(19) United States
(12) Patent Application Publication
(10) Pub. No.: US 2020/0211097 A1
(43) Pub. Date: Jul. 2, 2020

(54) Online Auction Apparatus and Method

(71) Applicant: Brad Benson, San Ramon, CA (US)

(72) Inventor: Brad Benson, San Ramon, CA (US)

(21) Appl. No.: 16/729,200

(22) Filed: Dec. 27, 2019

Related U.S. Application Data
(60) Provisional application No. 62/785,664, filed on Dec. 27, 2018.

(51) Int. Cl. G06Q 30/08; G06Q 30/06

(52) U.S. Cl. CPC G06Q 30/08; G06Q 30/0623; G06Q 30/0611

(57) ABSTRACT

This invention relates to an apparatus and method for creating heighted competition amongst prospective buyers of an item on an online auction system. The method generally involves suspending an auction immediately upon receipt of a bid equal to or exceeding a minimum reserve price. During the suspension, notifications are sent to a closed group of potential bidders, the notifications including the amount of the bid that triggered the suspension, along with a limited duration and a resume time for a second, “bidding war” segment of the auction.

### CROSS-REFERENCE TO RELATED APPLICATIONS

This application claims priority to U.S. Provisional Application No. 62/785,664, filed Dec. 27, 2018, which is incorporated herein by reference.

### BACKGROUND

### Field of the Invention

This invention relates to online auctions and, more particularly, relates to an apparatus and method for creating heighted competition amongst potential buyers of an item on an online auction system.

### Discussion of the Prior Art

In a traditional online auction, a user may visit a web page where the online auction is being hosted, view items that are for sale, and enter one or more bids on an item until a specified auction end time is reached. Generally, the user with the highest bid wins the auction and the opportunity to purchase the item for the bid price. The auction apparatus and method described below improves upon online auction systems by creating heightened competition amongst prospective buyers of an item for sale.

### SUMMARY OF THE INVENTION

The present invention is directed to an auction apparatus and a method that performs the functions of the auction apparatus. The method generally involves suspending an online auction immediately upon receipt of a bid equal to or exceeding a reserve price. During the suspension, notifications are sent to a closed group of potential bidders. The notifications include the amount of the bid that triggered the suspension, along with a limited duration and resume time for a second “bidding war” segment of the auction.

The limited duration of the “bidding war” segment of the auction creates a heightened sense of urgency and increased competition amongst prospective buyers of the item for sale. By virtue of the invention, a seller is able to expedite the online auction, maximize the selling price of the item and guarantee that the item is sold for at least the minimum reserve price.

### BRIEF DESCRIPTION OF THE DRAWINGS

Exemplary embodiments of the invention will now be described with reference to the accompanying drawings, in which:

FIG. 1 is a schematic block diagram of one embodiment of an online auction system according to the invention.

FIG. 2 is a schematic block diagram of one embodiment of an auction module according to the invention.

FIG. 3 is a schematic flowchart diagram of one embodiment of an auction method according to the invention.

### DETAILED DESCRIPTION OF THE ILLUSTRATED EMBODIMENTS

Aspects of the invention may be embodied as a system, method, and/or computer program product. Accordingly, aspects of the invention may take the form of an entirely hardware embodiment, an entirely software embodiment or an embodiment combining software and hardware aspects that may all generally be referred to herein as an “apparatus”, “system” or “module”. Furthermore, aspects of the present invention may take the form of a computer program product embodied in one or more computer readable mediums having program code embodied thereon.

Many of the functional units described in this specification have been labeled as modules, in order to more particularly emphasize their implementation independence. A module may be implemented in programmable hardware or in software for execution by various types of processors. Nevertheless, the executables of an identified module need not be physically located together bur may comprise disparate instructions stored in different locations which, when joined logically together, comprise the module and achieve the stated purpose for the module.

A module of program code may be a single instruction, or many instructions, and may be distributed over several different code segments, among different programs, and across several devices. Similarly, data operated on by the modules may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored in and/or propagated on one or more computer readable mediums.

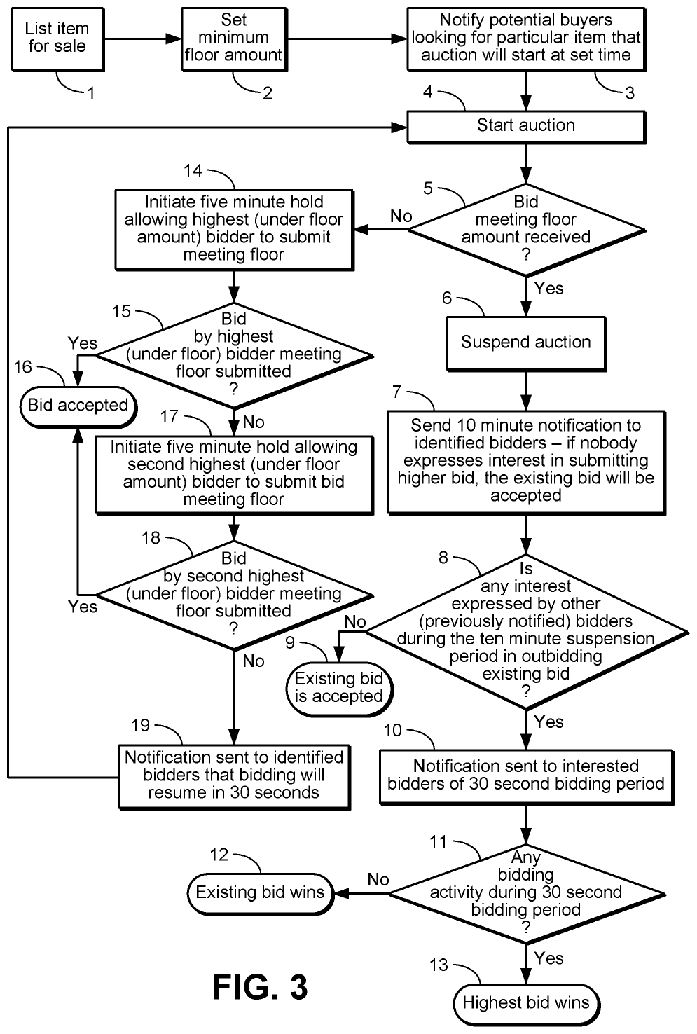

Some embodiments of the invention are described below with reference to a schematic flowchart diagram (FIG. 3). It will be understood that each block of the schematic flowchart diagram and combinations of blocks in the schematic flowchart diagram can be implemented by program code. The program code may be provided to a processor of a computer, sequencer, or other programmable data processing apparatus to produce a machine, such that the instructions, which execute via the processor of the computer or other programmable data processing apparatus, create means for implementing the functions specified in the flowchart diagram block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function specified in the flowchart diagram block or blocks.

Each block in the schematic flowchart diagram may represent a module, segment, or portion of code, which comprises one or more executable instructions of the program code for implementing the specified logical functions. It should be noted that, in some alternative implementations, the functions noted in the block may occur out of the order noted in the flowchart diagram. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the flowchart diagram. Although various arrow types and line types may be employed in the flowchart diagram, they are understood not to limit the scope of the corresponding embodiments.

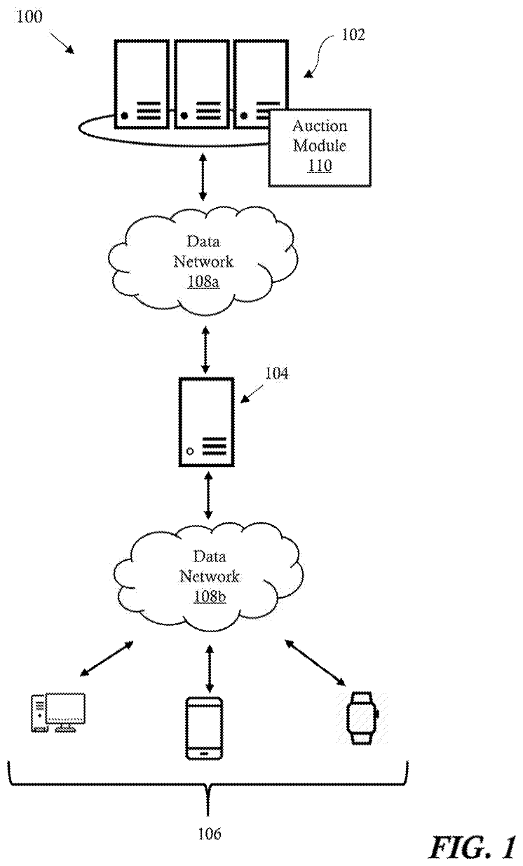

With reference to FIG. 1, an online auction system 100 includes one or more auction management devices or apparatuses 102 such as servers, desktop computers, laptop computers, or the like. Auction management devices 102 are configured to store, access, host, process, coordinate, synchronize, or the like, data associated with an online auction.

The online auction system 100, includes one or more computing devices 104, such as servers, configured to be an auction platform. An auction platform 104, as used herein, is a platform configured to host an online auction. In one embodiment, the auction platform 104 may present an interface, such as a web page, for users to post listings for items for sale, bid on items for sale, buy items for sale, view items for sale, or the like. In a traditional online auction, for example, a user may visit a web page where the auction is being hosted, view products that are for sale, and enter one or more bids on the products until a specified auction end time is reached. Generally, the user with the highest bid wins the auction and the opportunity to purchase the product for the bid price. The auction platform 104 may be configured to host auctions for various products, such as vehicles, electronics, tools, clothes, furniture, or the like.

In certain embodiments, users interact with the auction platforms 104 using one or more personal computing devices 106, such as desktop computers, laptop computers, tablet computers, smart phones, smart watches or other wearable devices, smart TVs, or the like that are communicatively coupled to the auction platform 104 via a network 108b. For example, a user may visit a web site hosted by the auction platform 104 using a phone or tablet computer. The user may use the interface provided by the auction platform 104 to view items for sale, bid on an item for sale, complete a purchase for an item, or the like.

In one embodiment, the personal computing devices 106 are communicatively coupled to the auction platforms 104 via a first data network 108b. Similarly, the auction platform 104 is communicatively coupled to the auction management devices 102 via a second data network 108a. In some embodiments, the first data network 108b is the same data network as the second data network 108a, such as the Internet.

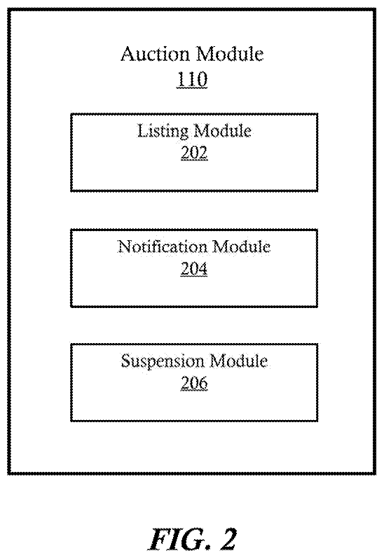

In one embodiment, an auction module 110, which at least a portion of may be located on one or more of the auction management devices 102, the auction platform 104, and/or the personal computing devices 106. facilitates the monitoring, maintenance, management, or the like of item listings on the auction platform 104. As described below with reference to FIG. 2, the auction module 110 may utilize one or more different modules to perform the functions of the auction module 110.

In certain embodiments, the auction module 110 communicates with the auction platform 104 using web services or other mechanisms. As used herein, web services are methods of communication between two devices over a data network 108a, 108b.

With reference to FIG. 2, an auction module 110, includes one or more of a listing module 202, a notification module 204 and a suspension module 206.

The listing module 202, in one embodiment, is configured to create, modify or delete a listing for an item for sale on the auction platform 104. The listing, in certain embodiments, may include various information describing the item for sale including the initial bid price, a floor or reserve price (the lowest price the seller is willing to accept), an auction end time, a “buy it now” price, a product description, images of the product, seller information, or the like. For example, the listing module 202 may create a listing for a vehicle that includes an initial bid price of $10,000, a reserve price of $10,000, an end date set for one week from the time the listing is posted, the vehicle identification number (“VIN”), images or videos of the vehicle, and a description of the vehicle.

The listing module 202, as described above, may communicate with the auction platform 104 via one or more of the data networks 108a, 108b using a web service to send the item listing to the auction platform 104. In response to receiving the listing for the item, the auction platform 104 may post the listing on its interface, e.g., website, for users to view and bid on.

In one embodiment, the notification module 204 is configured to receive notifications from the auction platform 104 in response to an auction event associated with an item listing. The auction event, in some embodiments, includes listing of an item, receiving a bid for a listed item, a “buy it now” purchase of the item, removal of the listing from an auction platform 104, expiration of the listing of the item, or the like. The notification received by the notification module 204 may include the type of auction event and information associated with the auction event. For example, the notification module 204 may receive a bid notification, indicating that the listing received a bid from a user, and the amount of the bid, the new bid price, and/or the date/time of the bid.

In some embodiments, an auction event on the auction platform 104 can occur in response to a communication received by the auction platform 104 from the personal computing devices 106. Such communications can include, for example, notifications from the personal computing devices 106 indicating interest in or placing a bid on an item listing. The notification module 204 is configured to receive such notifications either directly from the personal computing devices 106 or from the personal computing devices 106 via the auction platform 104 over one or more of the data networks 108a, 108b.

In some embodiments, the notification module 204 is configured to send notifications to the personal computing devices 106, either directly or via the auction platform 104 over the data networks 108a, 108b. Such notifications may include, for example, a start time or duration of an auction event, the amount of a bid received from another user, the pausing or suspension of an auction, or the occurrence of other auction events on the auction platform 104.

In some embodiments, the suspension module 206 is configured to suspend a listing of an item, i.e., auction, for a duration of time during which the notification module may send or receive notifications to the auction platform 104 and/or the personal computing devices 106 over one or more of the data networks 108a, 108b.

With reference to FIG. 3, an exemplary auctioning method according to the invention begins at step 1 with the listing of an item for sale on the auction platform 104. The listing may include text, image or video data. For example, in a vehicle auction, the listing may include a video file providing detailed information pertinent to potential buyers of a vehicle for sale. The video would generally begin with a review of the outside of the vehicle including descriptions of the right quarter panel showing any paint work or damage, the wheels describing any damage and tire tread depth, the fenders, hood, windshield, roof, doors, quarter panels and trunk lid. In the video, a review of the outside of the vehicle may be follow by a video survey of the inside of the vehicle, including noting any wear or damage and comments on any undesirable odors.

After listing the item for sale on the auction platform, the method sets a minimum bid amount, i.e., reserve price or floor bid, at step 2. As described in further detail below, a bid that meets or exceeds the minimum bid amount may trigger further steps in the method. In some embodiments, the listing module 202 is configured to list the item for sale on the auction platform 104 and to set the minimum bid amount.

Potential buyers of the item for sale are then notified that the auction will start at a set time, at step 3. Potential buyers are those identified, for example, in the system memory of one or more of the auction devices 102, auction platform 104 or personal computing devices 106, as those looking for an item similar to the item to be auctioned. For example, in a vehicle auction, automobile dealerships will generally consistently be looking for specific vehicle makes and models. In some embodiments of the invention, the notification module 204 selects a grouping of the personal computing devices 106 based on information on the item for sale and sends on-sale notifications to the selected grouping of the personal computing devices 106. The on sale notifications may include one or more descriptions of the item for sale and a start time for the auction on the auction platform 104

After commencement of the auction, at step 4, when the first bid is submitted that meets the floor bid amount, at step 5, the auction is suspended immediately, at step 6, and a notification is sent to all interested bidders that the extant bid will be accepted unless another bidder expresses interest in submitting a higher bid in the next ten minutes, at step 7. In one embodiment of the auction system, any higher bid submitted must be at least an established dollar amount higher than the extant bid, e.g., one hundred dollars. If no interest is expressed during the suspension period at step 8, the bid submitted at step 5 that met the floor bid amount will be accepted, at step 9. In some embodiments, the suspension module 204 is configured to suspend the auction on the online auction platform 104.

If interest in outbidding the existing bid is expressed during the ten-minute suspension period at step 8, interested bidders will receive notification that bidding will recommence at a set time for a thirty second period, at step 10. If during the thirty second bidding period, at step 11, no one submits a bid the existing bid is accepted, at step 12. If one or more bids are submitted during the thirty second bidding period, the highest bid wins, at step 13. In some embodiments, the notification module 202 is configured to send notifications to the personal computing devices 106 that include a query of interest in the item for sale and is configured to receive indications of interest in the item for sale from the personal computing devices 106.

Returning now to step 5, if no bids are submitted within a preestablished bidding window, e.g., five minutes, but bids are submitted below the floor bid amount, the auction will be suspended for five minutes, at step 14, to allow the highest (under floor amount) bidder to submit a bid meeting the floor bid amount. If during the five-minute suspension, at step 15, the highest (under floor amount) bidder submits a bid meeting the floor bid amount, that bid is accepted at step 16. If the highest bidder (under floor amount) does not submit a bid meeting the floor bid amount, at step 15, and if one or more under floor amount bids have been submitted, the auction will continue to be suspended for a second five minute period, at step 17, to allow the second highest (under floor amount) bidder to submit a bid meeting the floor bid amount. If second highest (under floor amount) bidder submits a bid meeting the floor bid amount during the second five-minute suspension period, at step 18, that bid will be accepted, at step 16. If during the second five-minute suspension period, at step 18, no bid is submitted by the second highest (under floor amount) bidder, notification is sent to interested bidders that the auction will resume in thirty seconds and the process repeats until the vehicle is sold. If the vehicle is not sold after a set period, the seller may adjust the floor bid amount downward or elect to remove the vehicle from sale under the auction system. In one embodiment of the auction system, if no bid is submitted that meets the floor bid amount within a set period, e.g., three hours, the seller may lower the floor bid amount in which case notification is sent to interested bidders that a brief bidding window, e.g., thirty seconds, will open shortly. In some embodiments, the listing module 202 is configured to resume the auction and/or modify the item listing and the notification module 204 is configured to perform the method steps of sending and receiving notifications to or from the personal computing devices 106.

The improved auction apparat us and method of the invention has the distinct advantage that, by alerting interested bidders that a potentially winning bid has been submitted, and that the auction will be suspended to entertain competing higher bids during a very short, “bidding war” segment of the auction, a sense of urgency is created amongst the bidders that generates heightened interest in the item for sale, which encourages a successful and timely sale of the item for at least the seller's established reserved price.

Certain embodiments of an auction apparatus and method have thus been described and illustrated herein in detail. These embodiments are merely example implementations of the invention and are not to be taken as limiting, the spirit and scope of the invention being limited only by the terms of the appended claims and their legal equivalents.

What is claimed is:

1. An auction method comprising:
listing, on an online auction system, an item for sale, the online auction system being connected to a plurality of computing devices,
receiving, during a first segment of a bidding period, a first segment bid notification from one of the plurality of computing devices, the first segment bid notification including an offer price for the item equal to or exceeding a minimum floor price for the item,
suspending the bidding period immediately upon receipt of the first segment bid notification, and
sending suspension notifications to the plurality of computing devices, the suspension notifications each comprising the offer price included in the first segment bid notification and a limited duration and a recommencement time for a second segment of the bidding period.

2. The auction method of claim 1, further comprising:
receiving, during the second segment of the bidding period, one or more second segment bid notifications from the plurality of computing devices.

3. The auction method of claim 2, the second segment bid notifications each comprising:
an offer price for the item exceeding the offer price included in the first segment bid notification.

4. The auction method of claim 1, further comprising:
receiving, in response to the suspension notifications, indications of interest in the item for sale from the plurality of computing devices,
selecting a group of the plurality of computing devices based on the indications of interest in the item for sale, and
receiving, during the second segment of the bidding period, one or more second segment bid notifications from the selected group of computing devices, the second segment bid notifications each including an offer price for the item exceeding the offer price included in the first segment bid notification.

5. The auction method of claim 1, the listing step further comprising:
listing, on the online auction system, item information including one or more descriptions of the item for sale,
selecting a group of the plurality of computing devices based on one of the one or more descriptions of the item for sale, and
sending on-sale notifications to the selected group of the computing devices, the on-sale notifications including one or more of the descriptions of the item for sale and a start time for the first segment of the bidding period.

6. An auction apparatus comprising:
a processor configured to communicate with a plurality of computing devices; and
a memory that stores code executable by the processor to:
send item information to the plurality of computing devices, the item information including one or more descriptions of an item for sale,
receive, during a first segment of a bidding period, a first bid notification from one of the plurality of computing devices, the first bid notification including an offer price for the item for sale equal to or exceeding a minimum floor price for the item,
suspend the bidding period immediately upon receipt of the first bid notification, and
send suspension notifications to the plurality of computing devices, the suspension notifications each comprising the offer price included in the first bid notification and a limited duration and a recommencement time for a second segment of the bidding period.

7. The auction apparatus of claim 6, the memory further storing code executable by the processor to:
receive, during the second segment of the bidding period, one or more second segment bid notifications from the plurality of computing devices.

8. The auction apparatus of claim 7, the second segment bid notifications each comprising:
an offer price for the item exceeding the offer price included in the first segment bid notification.

9. The auction apparatus of claim 6, the memory further storing code executable by the processor to:
receive, in response to the suspension notifications, indications of interest in the item for sale from the plurality of computing devices,
select a group of the plurality of computing devices based on the indications of interest in the item for sale, and
receive, during the second segment of the bidding period, one or more second segment bid notifications from the selected group of computing devices, the second segment bid notifications each including an offer price for the item exceeding the offer price included in the first segment bid notification.

10. The auction apparatus of claim 6, the memory further storing code executable by the processor to:
list, on the online auction system, item information including one or more descriptions of the item for sale,
select a group of the plurality of computing devices based on one of the one or more descriptions of the item for sale, and
send on-sale notifications to the selected group of the computing devices, the on-sale notifications including one or more of the descriptions of the item for sale and a start time for the first segment of the bidding period.

11. An auction method comprising:
listing, on an online auction system, item information including one or more descriptions of an item for sale, the online auction system being connected to a plurality of computing devices,
selecting a first grouping of the plurality of computing devices based on the item information,
receiving, during a first segment of a bidding period, a first segment bid notification from one of the selected first grouping of computing devices, the first segment bid notification including an offer price for the item for sale equal to or exceeding a minimum floor price for the item for sale,
suspending the bidding period immediately upon receipt of the first segment bid notification, and
sending suspension notifications to the selected first grouping of computing devices, the suspension notifications each comprising the offer price included in the first segment bid notification and a limited duration and a recommencement time for a second segment of the bidding period,
receiving, in response to the suspension notifications, indications of interest in the item for sale from the first grouping of computing devices,
selecting a second grouping of the plurality of computing devices based on the indications of interest in the item for sale, and
receiving, during the second segment of the bidding period, one or more second segment bid notifications from the selected second grouping of computing devices, the second segment bid notifications each including an offer price for the item for sale exceeding the offer price included in the first segment bid notification.
